(19) United States
(12) Patent Application Publication
(10) Pub. No.: US 2006/0075401 A1
(43) Pub. Date: Apr. 6, 2006

(54) Patch installation control

(75) Inventor: Stephen Michael Smegner, Coppell, TX (US)

Correspondence Address: BINGHAM, MCCUTCHEN LLP, THREE EMBARCADERO CENTER, 18 FLOOR, SAN FRANCISCO, CA, 94111-4067, US

(73) Assignee: Microsoft Corporation, Redmond, WA (US)

(21) Appl. No.: 10/959,287

(22) Filed: Oct. 5, 2004

(51) Int. Cl. G06F 9/445

(52) U.S. Cl. 717/174

(57) ABSTRACT

Patch installation control is described, including evaluating a system registry for a system identification, determining an installation case based on the system identification, and installing a patch if the installation case indicates a first result. A system for controlling patch installation is also described, including a registry configured to store configuration data including a system identification and a patch installer configured to determine an installation case based on the system identification and install a patch if the installation case indicates a first result. A computer program product for controlling patch installation, the computer program product being embodied in a computer readable medium and comprising computer instructions for evaluating a system registry for a system identification, determining an installation case based on the system identification, and installing a patch if the installation case indicates a first result.

### FIELD OF THE INVENTION

The present invention relates generally to software. More specifically, patch installation control is described.

### BACKGROUND OF THE INVENTION

Patching software programs, systems, or applications (“applications”) may be used to modify existing functionality. Applications of various types include large-scale enterprise systems, standalone programs, web services, client or server-side applications, and others. Patches are implemented to upgrade, maintain, or correct existing functionality. However, patches are often uncontrolled and may be downloaded and installed without restriction.

Downloading and installing patches may involve modifying existing code underlying an application. Generally, patch installation may be uncontrolled, permitting the unrestricted modification of existing or platform applications. In examples such as government-reviewed (e.g., under HIPAA, FDA) applications, approval may be rendered invalid if the underlying source or object code has been modified beyond restrictions provided for under the existing regulatory approval. In some cases, uncontrolled downloading and installation of patches may create problems with regard to licensing, distribution, and redistribution agreements. Although a user may be required to register and provide personal or business-related information to download and install a patch, this is not an effective safeguard as false information may be provided and no assurances are provided that an application is being correctly patched. Further, download and installation may be conditioned upon the registration of licensing information, which may not be cross-referenced with a vendor's records.

Thus, what is needed is a solution for patch installation without the limitations of conventional implementations.

### BRIEF DESCRIPTION OF THE DRAWINGS

Various embodiments of the invention are disclosed in the following detailed description and the accompanying drawings:

FIG. 1A illustrates an exemplary system for controlling patch installation;

FIG. 1B illustrates another exemplary system for controlling patch installation;

FIG. 2 illustrates an exemplary process for controlling patch installation;

FIG. 3 illustrates an exemplary process for determining a patch installation case;

FIG. 4 illustrates an exemplary process for evaluating a patch;

FIG. 5 illustrates an exemplary process for modifying a patch;

FIG. 6 illustrates an exemplary process for installing a patch having a timeout;

FIG. 7 illustrates an exemplary process for controlling secure patch installation; and

FIG. 8 is a block diagram illustrating an exemplary computer system suitable for controlling patch installation.

### DETAILED DESCRIPTION OF THE PREFERRED EMBODIMENTS

The invention can be implemented in numerous ways, including as a process, an apparatus, a system, a composition of matter, a computer readable medium such as a computer readable storage medium or a computer network wherein program instructions are sent over optical or electronic communication links. In this specification, these implementations, or any other form that the invention may take, may be referred to as techniques. In general, the order of the steps of disclosed processes may be altered within the scope of the invention.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Applications often deploy corrective or preventive modifications such as patches to update or correct existing functionality. A patch may be a program or program segment that enables the modification of existing code (e.g., object) in order to change, add, or delete functionality in an application. Once integrated and compiled, a patch enables source code associated with an application to implement new or modified functionality. Patches may be implemented for various purposes including security upgrades, modifying or adding functionality, or correcting previously unknown defects uncovered by users. By controlling the distribution and installation of patches, applications may be patched and used to avoid invalidating warranties, regulatory approvals, or other certifications associated with the applications.

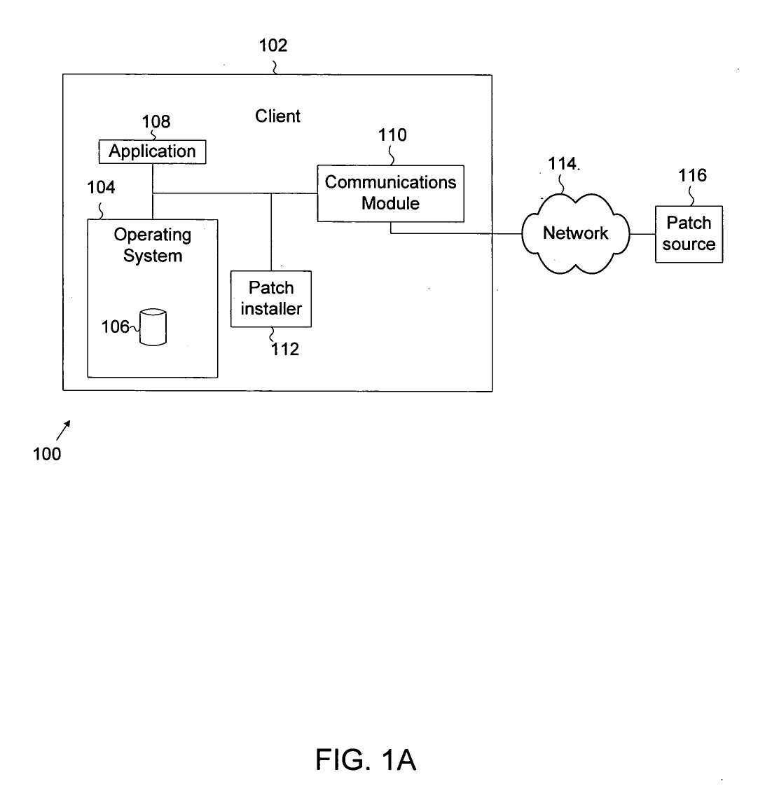

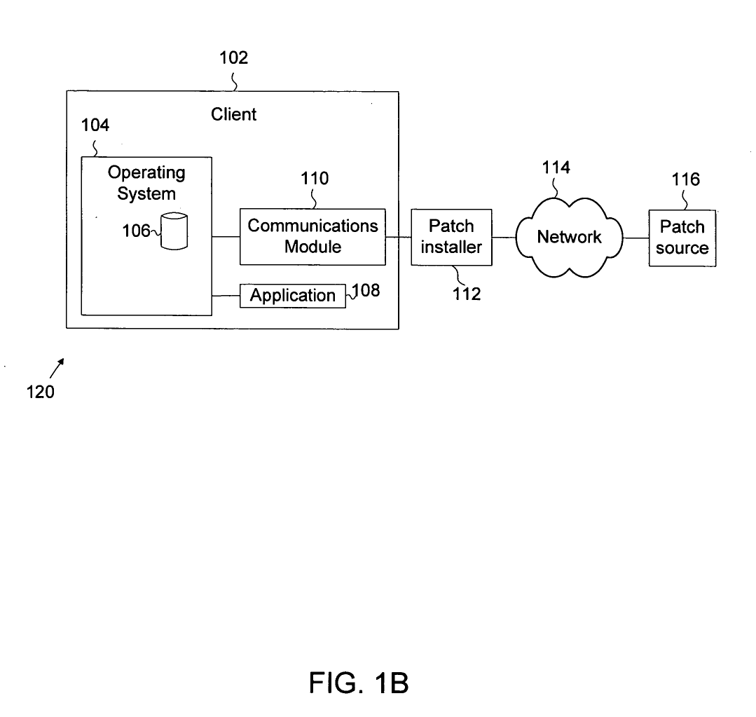

FIG. 1A illustrates an exemplary system for controlling patch installation. As an example, system 100 includes client 102, which also has operating system 104, system registry 106, application 108, communications module 110 and patch installer 112. Client 102 communicates over network 114 with patch source 116. Network 114 may include a local area network (LAN), wide area network (WAN), the Internet or other type of network used to transfer data between one or more endpoints such as client 102. In this example, client 102 includes patch installer 112. However, in other examples, patch installer 112 may be implemented as a separate device, system, or process, as illustrated in FIG. 1B. In some examples, patch installer 112 may also be implemented as a separate or included component of a patch. In other examples, patches may be distributed directly to a client using a floppy disk, CD, DVD, or other form of removable disconnected media in contrast to the example illustrated in FIG. 1. Client 102 initiates a request for a patch to be downloaded to a memory (not shown), from which installation may occur.

As an example, an automatic or manual request may be made from client 102 to download and install a patch using patch installer 112. A patch may be retrieved from patch source 116 (e.g., vendor location or website). Patch source 116 may be implemented using a client or server-side repository such as a database, storage device or system, data construct (e.g., virtual storage area networks or network attached storage systems), or other data structures used to store information and data. A patch may be a program, section, or block of code (e.g., object) used to modify another program such as application 108. Application 108 may be implemented as a computer program such as a client or server-side program intended to perform a function or set of functions when executed. Patches may be useful to ensure that operation, integrity, security, and reliability of applications are maintained.

When initiated, patch installer 112 may be used to direct the retrieval, download, and installation of a patch from patch source 116. Patch installer may also be included with a patch and, when installed, performs a validation process to ensure the patch is installed with the correct application or system. In some examples, these patches may be downloaded to a client using a floppy disk, CD, DVD, compact flash memory card, or other removable disconnected data storage and transfer media. Regardless, patches may include patch installers that implement functionality such as that described. A patch may be installed on operating system 104, application 108, or elsewhere on client 102. In some examples, a patch may be downloaded to another device, system, or process that is remotely located from client 102. When executed, a patch may be installed onto client 102, integrating, for example, with an executable application such as application 108. As an example, a patch may be used to modify object code associated with application 108 that, when executed, modifies the resulting source or executable code and resulting functionality. Patches may be used to modify or correct an existing application, but may also be used to implement new functionality. Another example of a system for patch installation is shown in FIG. 1B.

FIG. 1B illustrates another exemplary system for controlling patch installation. In this example, system 120 also includes client 102, operating system 104, system registry 106, application 108, and communications module 110. However, patch installer 112 may be implemented as an external component or system from client 102, as illustrated in this example. Patch installer 112 may be used to retrieve a patch over network 114 from patch source 116.

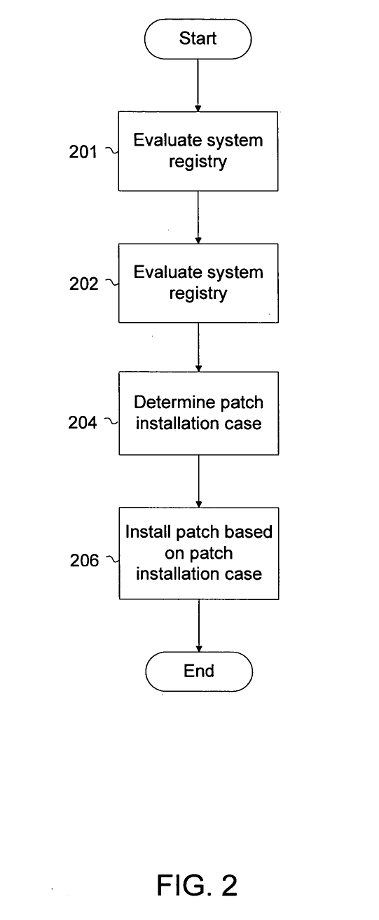

In this example, patch installer 112 may be implemented externally to client 102. As a separate device, system, or process, patch installer 112 may be remotely located to client 102. As an example, patch installer 112 may be installed on a server in a network (not shown). Client 102 may be a host, machine, or computer on a network. Remote communication enables one or more clients to access patch installer 112. In some examples, a single patch installer may be used to provide patch installation for multiple clients. Patch installation is described in greater detail below in connection with FIGS. 2-7.

FIG. 2 illustrates an exemplary process for controlling patch installation. As an example, patch installer 112 may execute the following process by selecting a patch (201). Here, when a patch is selected, a system registry (e.g., Windows registry, configuration file, system registry 106) is evaluated (202). System registry 106 may include a data base, storage system, file, or other type of data structure used to store information such as configuration data. Configuration data may be used to administer operating system 104, application 108, or other systems associated with client 102. From information and data obtained during the evaluation of system registry 106, a patch installation case is determined (204). As an example, a patch installation case may be a set of parameters, rules, or instructions that are pertinent to a particular patch. A patch installation case ensures that the correct patch is downloaded and installed with a particular application, preventing unrestricted modification of object code that may cause an application to become, for example, decertified, non-compliant (i.e., with HIPAA) or subject to a loss of governmental (e.g., FDA) approval. Parameters included in a patch installation case may include security, access, authentication, version, installation, or other types of data used to determine whether a patch may be installed. Based on the patch installation case, a patch may be installed (206).

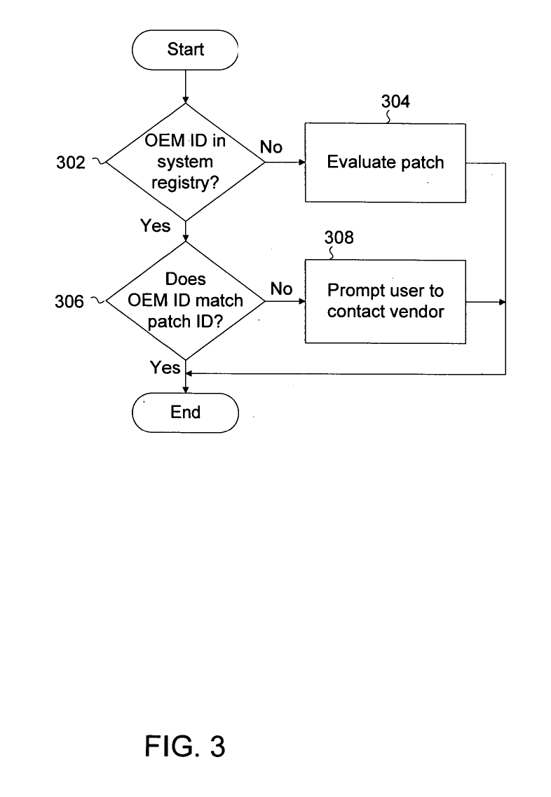

FIG. 3 illustrates an exemplary process for determining a patch installation case. Here, an identifier may be used to determine whether a system may download and install a patch. Information associated with an identifier determines parameters governing the download and installation of a patch. In this example, patch installer 112 determines whether an original equipment manufacturer (e.g., OEM) identifier (ID) is in system registry 106 (302). In other examples, identifiers other than an OEM ID may be used. However, identifiers and OEM ID may be used interchangeably in the examples described. Identifiers may also be used to identify a patch, application, or other program portion. Here, an identifier such as an OEM ID may be used to indicate a revision, version, or release of a particular patch or application. An identifier may also be used to identify whether a patch may be downloaded and installed on a particular system or application.

If an OEM ID is not found in system registry 106, then a selected patch is evaluated (304). However, if an OEM ID is found in system registry 106, then the OEM ID is compared to a patch ID (306). However, if a patch does not have a patch ID or the patch ID does not match the OEM ID, then patch installer 112 may generate a message to a vendor or patch provider/developer indicating that the selected patch may be invalid or incorrect (308).

The use of an identifier such as an OEM ID enables control over patches and patch installation. By controlling patch installation, operating systems, and other software systems installed on client 102, compliance with regulatory, certification, or other approval measures (e.g., FDA, HIPAA, etc.) may be retained. These techniques enable an application to be patched after receiving certification or approval, without losing regulatory approval. In these examples, installation cases are determined. Installation cases provide instructions to patch installer 112 for retrieving a patch from patch source 116 and installing the patch onto operating system 104, application 108, or another component associated with client 102. Subsequently, patch installation may be performed after determining an installation case for a selected patch.

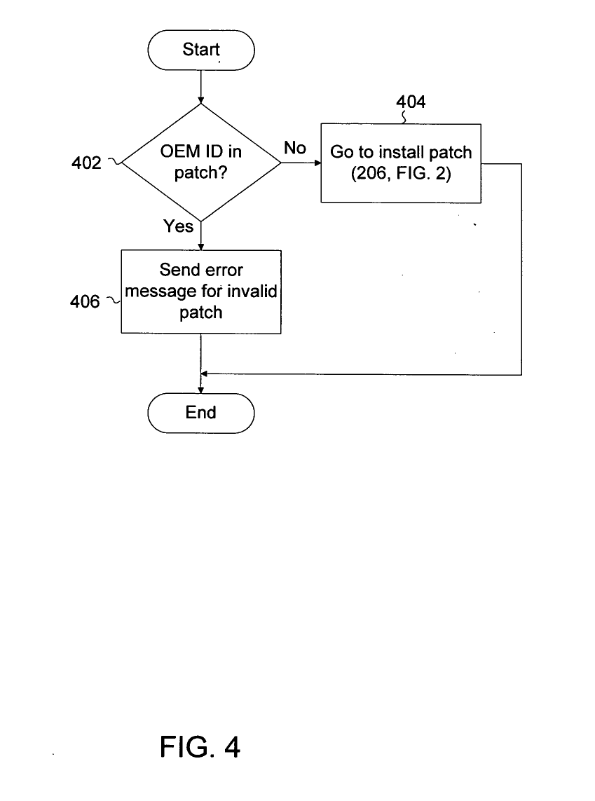

FIG. 4 illustrates an exemplary process for evaluating a patch. In the example of FIG. 3, if an OEM ID is not found in system registry 112, then this exemplary process may be performed to evaluate a patch. After determining that system registry 112 does not have an OEM ID, a determination is made as to whether the OEM ID is in the patch (402). If a determination is made that neither an OEM ID nor a patch ID are included in either system registry 112 or the selected patch, then patch installation may be performed (404). However, if the OEM ID is found in a selected patch, then an error message is generated indicating that an invalid patch has been found. In this example, matching identifiers in both system registry 106 and a selected patch indicate that the patch is valid and available for installation. As an example, an error message may be sent to either a user or vendor, indicating that an invalid patch has been found. The error message may also be used to request an updated, valid patch or automatically request, retrieve, and download a patch into patch source 116 for future use. Other examples may be found for sending an error message.

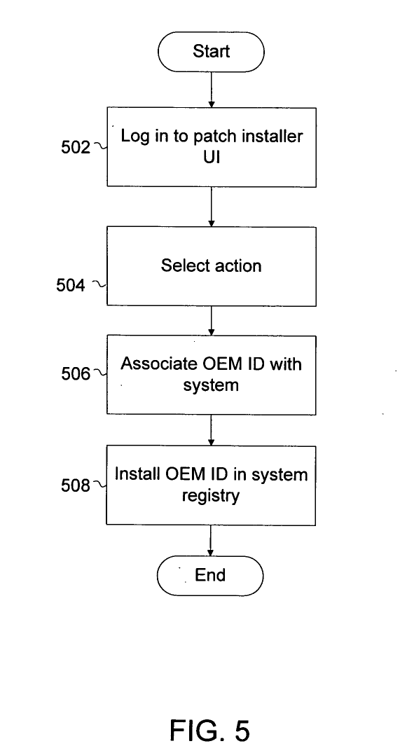

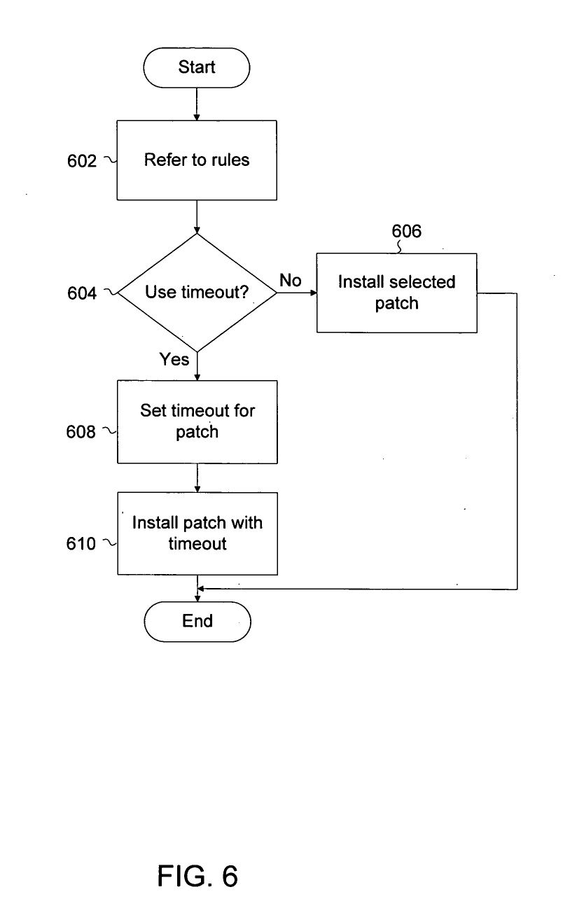

FIG. 5 illustrates an exemplary process for modifying a patch. As an example, an OEM ID may be modified by a user, vendor, or other third party. A third party may log into patch installer 112 using, for example, a patch installer user interface (UI) (502). Once logged in, a user may select an action (504). Examples of an action may include adding, deleting, replacing, or modifying a patch. Other examples may include modifying configuration information associated with a particular patch. Still other examples may include providing authentication or encryption information for ensuring a patch may be retrieved, downloaded, and installed by licensed or authorized parties. After selecting an action such as those described above, a system may be associated with an OEM ID (506). Associating an OEM ID with a system ensures that patches intended for installation with applications or systems with a matching identifier are allowed to install. This prevents improper, unauthorized, or incorrect patches from download and installation. As an example, if a particular software system or application has been approved for a particular use (e.g., FDA approval of equipment in drug manufacturing uses), approval may not be rendered invalid because of a subsequent patch installation that may alter the basic application. In other examples, limited licenses or installations may be used to control the distribution and installation of patches, as described in FIG. 6.

FIG. 6 illustrates an exemplary process for installing a patch having a timeout. Here, an example is provided for a process that may be implemented to limit the use of installed patches by employing a timer or timeout mechanism. When a patch is selected for installation, as in FIG. 2, patch installer 112 refers to rules governing patch installation (602). Rules may include user-specified, automatic or machine-generated instructions and parameters that govern patch installation. After referring to rules associated with the selected patch, a determination is made as to whether a timeout is to be used (604). If no time out is used, then the selected patch may be installed (606). However, if a timeout is used, then the timeout is set for the selected patch (608). A timeout may be set according to user input or automatically-generated rules. As an example, a rule may specify that certain patches are to be installed with a timeout set for 30, 60, or 90 days, after which a license for the patch expires and, therefore, the patch and any functionality affected by it in the application, are disabled. This may restore functionality to an application to its original state prior to the installation of the patch. Once a patch has been implemented with the timeout, it may be installed (610). Another example of a timeout may be implemented as a timer included as part of the patch code.

As an example, a patch may be downloaded with an embedded timer. After installation, the timer is set to time out after a finite period, after which the patch would no longer install to a client. For example, a patch may time out using a timer mechanism that blocks a patch from installing. If a patch is issued for a finite period, say, 90 days then the patch would not install after the period has expired. Alternatively, if an OEM processes a patch for 90 days, then copies of the patch would expire and no longer install after 90 days. In this example, the use of a timer enables a recall mechanism that prevents stale code from being implemented outside of the control of a patch developer.

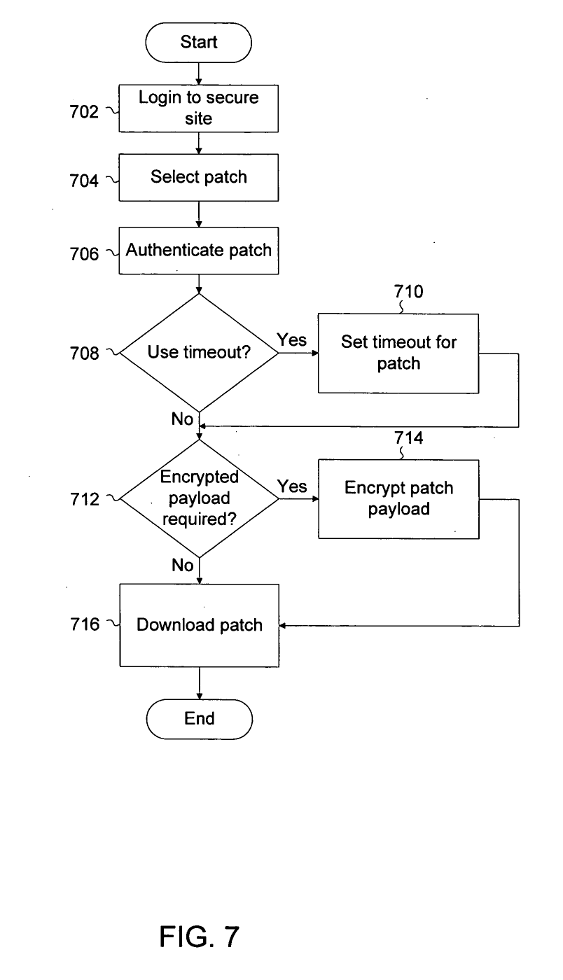

FIG. 7 illustrates an exemplary process for controlling secure patch installation. As an alternative process, patches may be downloaded in a secure manner. Here, a user or vendor may log into a secure site using a UI (702). Once logged in, a patch may be selected for download and installation (704). When a patch has been selected, authentication may be performed (706). Authentication may be performed to ensure a selected patch is installed. Authentication may also be performed to ensure that a particular user or client is authorized to download and install the patch. In other examples, authentication may be performed for other purposes.

Once authenticated, a determination is made as to whether a timeout is requested (708). If a timeout is requested (e.g., limited duration license), then a timeout is set for the selected patch. Setting a timeout may be performed using a process such as that described in FIG. 6. In other examples, setting a timeout may be performed using different techniques. After setting a time out or if a timeout is not used, a determination is made as to whether the payload associated with the patch is to be encrypted (712). If the patch payload is to be encrypted, then encryption is performed (714). If the payload patch is not encrypted, then the patch may be downloaded (716). This process is an alternative example of performing patch installation and may be used to supplement, replace, or modify the above-described techniques.

In other examples, distribution or redistribution of patches may occur, providing end user license agreements (EULA) or other agreements associated with the download and installation of patches. By using a process such as that described above, the distribution and installation of patches may be controlled.

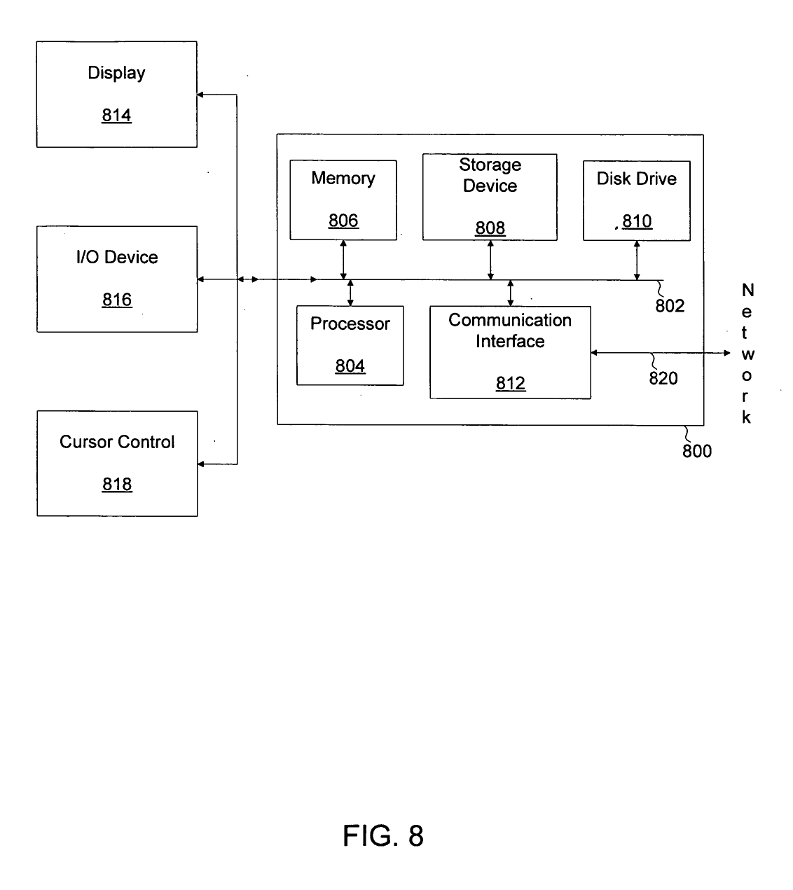

FIG. 8 is a block diagram illustrating an exemplary computer system suitable for controlling patch installation. In some examples, computer system 800 may be used to implement the above-described techniques. Computer system 800 includes a bus 802 or other communication mechanism for communicating information, which interconnects subsystems and devices, such as processor 804, system memory 806 (e.g., RAM), storage device 808 (e.g., ROM), disk drive 810 (e.g., magnetic or optical), communication interface 812 (e.g., modem or Ethernet card), display 814 (e.g., CRT or LCD), input device 816 (e.g., keyboard), and cursor control 818 (e.g., mouse or trackball).

According to one embodiment of the invention, computer system 800 performs specific operations by processor 804 executing one or more sequences of one or more instructions contained in system memory 806. Such instructions may be read into system memory 806 from another computer readable medium, such as static storage device 808 or disk drive 810. In alternative embodiments, hard-wired circuitry may be used in place of or in combination with software instructions to implement the invention.

The term “computer readable medium” refers to any medium that participates in providing instructions to processor 804 for execution. Such a medium may take many forms, including but not limited to, non-volatile media, volatile media, and transmission media. Non-volatile media includes, for example, optical or magnetic disks, such as disk drive 810. Volatile media includes dynamic memory, such as system memory 806. Transmission media includes coaxial cables, copper wire, and fiber optics, including wires that comprise bus 802. Transmission media can also take the form of acoustic or light waves, such as those generated during radio wave and infrared data communications.

Common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer can read.

In an embodiment of the invention, execution of the sequences of instructions to practice the invention is performed by a single computer system 800. According to other embodiments of the invention, two or more computer systems 800 coupled by communication link 820 (e.g., LAN, PSTN, or wireless network) may perform the sequence of instructions to practice the invention in coordination with one another. Computer system 800 may transmit and receive messages, data, and instructions, including program, i.e., application code, through communication link 820 and communication interface 812. Received program code may be executed by processor 804 as it is received, and/or stored in disk drive 810, or other non-volatile storage for later execution.

Although the foregoing embodiments have been described in some detail for purposes of clarity of understanding, the invention is not limited to the details provided. There are many alternative ways of implementing the invention. The disclosed embodiments are illustrative and not restrictive.

What is claimed:

1. A method for controlling patch installation, comprising:
evaluating a system registry for a system identification;
determining an installation case based on the system identification; and
installing a patch if the installation case indicates a first result.

2. The method recited in claim 1, further comprising accessing a secure patch site.

3. The method recited in claim 1, further comprising evaluating a patch based on the installation case.

4. The method recited in claim 1, further comprising accessing a site to configure the system identification.

5. The method recited in claim 1, further comprising accessing a site to associate the patch with the system.

6. The method recited in claim 1, wherein determining the installation case further comprises determining whether the identification is included in the system registry.

7. The method recited in claim 1, wherein determining the installation case further comprises matching the system identification to a patch identification.

8. The method recited in claim 1, wherein determining the installation case further comprises indicating a retail scenario if the system identification is not in the system registry or in the patch.

9. The method recited in claim 1, wherein determining the installation case further comprises indicating a vendor scenario if the system identification matches a patch identification.

10. The method recited in claim 1, wherein determining the installation case further comprises sending a message if the system identification does not match a patch identification.

11. The method recited in claim 1, wherein installing the patch further comprises including a timer with the patch.

12. The method recited in claim 1, wherein installing the patch further comprises authenticating the patch.

13. The method recited in claim 1, wherein installing the patch further comprises encrypting a payload associated with the patch.

14. The method recited in claim 1, wherein the first result indicates the patch is valid.

15. A system for controlling patch installation, comprising:
a registry configured to store configuration data including a system identification;
a patch installer configured to determine an installation case based on the system identification and install a patch if the installation case indicates a first result.

16. The system recited in claim 15, wherein the first result indicates the patch is valid.

17. The system recited in claim 15, wherein the patch installer does not install the patch if the installation case indicates a second result.

18. The system recited in claim 17, wherein the second result indicates the patch is invalid.

19. A computer program product for controlling patch installation, the computer program product being embodied in a computer readable medium and comprising computer instructions for:
evaluating a system registry for a system identification;
determining an installation case based on the system identification; and
installing a patch if the installation case indicates a first result.
